(19) United States
(12) Patent Application Publication
(10) Pub. No.: US 2009/0325009 A1
(43) Pub. Date: Dec. 31, 2009

(54) Electric power supply apparatus and portable electronic device having the same

(75) Inventors: Sung-Han Kim, Seoul (KR); Young-Soo Oh, Seongnam-si (KR); Craig Miesse, Seoul (KR); Hye-Yeon Cha, Yongin-si (KR); Jae-Hyuk Jang, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD, Suwon (KR)

(21) Appl. No.: 12/320,835

(22) Filed: Feb. 5, 2009

(30) Foreign Application Priority Data
Jun. 30, 2008 (KR) 10-2008-0062582

(51) Int. Cl. H01M 8/18; H01M 8/04

(52) U.S. Cl. 429/21; 429/22; 429/19; 429/23

(57) ABSTRACT

An electric power supply apparatus and a portable electronic device equipped with the electric power supply apparatus are disclosed. The electric power supply apparatus can include: a replaceable cartridge that supplies hydrogen or electrical power; a housing that forms a cavity, in which the cartridge may be inserted; a stack connected with the cartridge and configured, if the cartridge is supplying hydrogen, to receive the hydrogen from the cartridge and generate electrical power; and a circuit unit electrically connected with the cartridge and the stack that determines the type of the cartridge and supplies electrical power to the electronic device. With certain embodiments of the invention, a device can be recharged using replaceable cartridges. Also, various types of cartridges can be used in a single system, allowing a higher level of compatibility.

### CROSS-REFERENCE TO RELATED APPLICATIONS

This application claims the benefit of Korean Patent Application No. 10-2008-0062582 filed with the Korean Intellectual Property Office on Jun. 30, 2008, the disclosure of which is incorporated herein by reference in its entirety.

### BACKGROUND

1. Technical Field

The present invention relates to an electric power supply apparatus and to a portable electronic device equipped with the electric power supply apparatus.

2. Description of the Related Art

The conventional lithium ion battery has a relatively high energy density, and can thus be inserted as a power supply in various portable electronic devices, such as cell phones, PDA's (personal digital assistants), PMP's (portable media players), camcorders, laptops, etc. As such, the lithium ion battery has made a significant contribution to popularizing the use of portable electronic devices. However, with portable electronic devices providing increasingly higher performance, the operating times provided by conventional battery capacities have considerably shortened, and the resulting inconvenience experienced by the users has led to an increased demand for power sources that allow longer operating times. In this context, the fuel cell is currently receiving attention as a power source apparatus capable of providing longer operating times.

The fuel cell is an apparatus that converts the chemical energies of fuel (hydrogen, LNG, LPG, methanol, etc.) and air directly into electricity and heat, by means of electrochemical reactions. In contrast to conventional power generation techniques, which employ the processes of burning fuel, generating vapor, driving turbines, and driving power generators, the utilization of fuel cells does not entail combustion processes or driving apparatus. As such, the fuel cell is an attractive new technology for generating power that offers high efficiency and few environmental problems.

Examples of fuel cells being researched for application to portable electronic devices include the polymer electrolyte membrane fuel cell (PEMFC), which uses hydrogen as fuel, and the direct liquid fuel cell, such as the direct methanol fuel cell (DMFC), which uses liquid fuel directly.

### SUMMARY

One aspect of the invention provides an electric power supply apparatus for supplying electrical power to an electronic device. The electric power supply apparatus can include: a replaceable cartridge that supplies hydrogen or electrical power; a housing that forms a cavity, in which the cartridge may be inserted; a stack connected with the cartridge and configured, if the cartridge is supplying hydrogen, to receive the hydrogen from the cartridge and generate electrical power; and a circuit unit electrically connected with the stack that determines the type of the cartridge and supplies electrical power to the electronic device.

The cartridge can be one of a hydrogen generating device, a hydrogen storage tank, and an auxiliary battery.

The circuit unit can include a voltage sensor, to measure the voltage of the cartridge or the stack and sense whether the cartridge is supplying hydrogen or electrical power. The circuit unit can also include a circuit breaker, which may break the electric current flowing to the stack, if the voltage sensor senses that the cartridge is supplying electrical power.

The electric power supply apparatus can further include a manifold between the cartridge and the stack. If the cartridge is supplying hydrogen, the manifold may receive the hydrogen from the cartridge and transfer the hydrogen to the stack.

The cartridge can be a hydrogen generating device that includes metal electrodes which react with an electrolyte solution to generate hydrogen. In this case, the circuit unit can include a switch that controls the electric current flowing between the electrodes of the hydrogen generating device.

The circuit unit can include: a current sensor that measures the electric current flowing to the electronic device, and a control unit that controls the switch such that the hydrogen is generated in an amount corresponding to the current measured by the current sensor. Also, the circuit unit can include a converter that adjusts the voltage supplied from the cartridge or the stack.

A securing unit can be included, which may engage the cartridge when pressure is applied to the cartridge to insert the cartridge in the housing, and which may disengage the cartridge when pressure is applied again to the engaged cartridge.

The stack can be coupled to one side of the housing, and can have an opening formed in one side.

Another aspect of the invention provides a portable electronic device, which includes an electric power supply apparatus, and which is operated by electrical energy supplied by the electric power supply apparatus, where the electric power supply apparatus can include: a replaceable cartridge that supplies hydrogen or electrical power; a housing that forms a cavity, in which the cartridge may be inserted; a stack connected with the cartridge and configured, if the cartridge is supplying hydrogen, to receive the hydrogen from the cartridge and generate electrical power; and a circuit unit electrically connected with the cartridge and the stack that determines the type of the cartridge and supplies electrical power to the electronic device.

The cartridge can be one of a hydrogen generating device, a hydrogen storage tank, and an auxiliary battery.

The circuit unit can include a voltage sensor that measures the voltage of the cartridge or the stack and senses whether the cartridge is supplying hydrogen or electrical power. The circuit unit can also include a circuit breaker, which may break the electric current flowing to the stack, if the voltage sensor senses that the cartridge is supplying electrical power.

The electric power supply apparatus can further include a manifold between the cartridge and the stack. If the cartridge is supplying hydrogen, the manifold may receive the hydrogen from the cartridge and transfer the hydrogen to the stack.

The cartridge can be a hydrogen generating device that includes metal electrodes which react with an electrolyte solution to generate hydrogen. In this case, the circuit unit can include a switch that controls the electric current flowing between the electrodes of the hydrogen generating device.

The circuit unit can include: a current sensor that measures the electric current flowing to the electronic device, and a control unit that controls the switch such that the hydrogen is generated in an amount corresponding to the current measured by the current sensor. Also, the circuit unit can include a converter that adjusts the voltage supplied from the cartridge or the stack.

The electric power supply apparatus can further include a securing unit, which may engage the cartridge when pressure is applied to the cartridge to insert the cartridge in the housing, and which may disengage the cartridge when pressure is applied again to the engaged cartridge.

The stack can be coupled to one side of the housing, and can have an opening formed in one side.

The portable electronic device can further include a rechargeable main battery, where the electric power supply apparatus can be electrically connected with the main battery to recharge the main battery.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a perspective view of an embodiment of an electric power supply apparatus according to an aspect of the invention.

FIG. 2 is a conceptual diagram of an embodiment of an electric power supply apparatus according to an aspect of the invention.

FIG. 3 is a perspective view of an embodiment of a securing unit in an electric power supply apparatus according to an aspect of the invention.

FIG. 4 is a perspective view of an embodiment of a portable electronic device according to another aspect of the invention.

FIG. 5 is a perspective view of another embodiment of a portable electronic device according to another aspect of the invention.

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

The electric power supply apparatus and the portable electronic device equipped with the electric power supply apparatus, according to certain aspects of the invention will be described below in more detail with reference to the accompanying drawings. Those components that are the same or are in correspondence are rendered the same reference numeral regardless of the figure number, and redundant explanations are omitted.

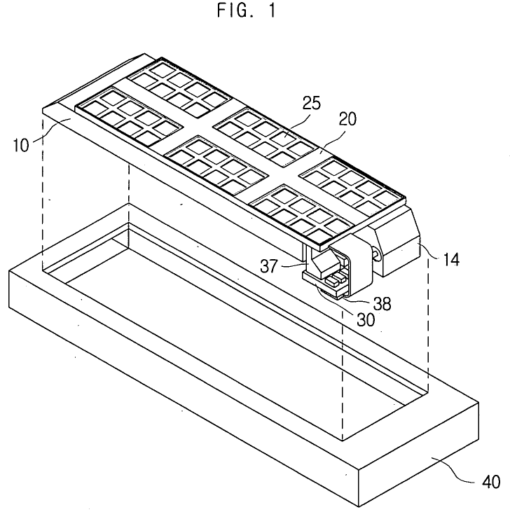

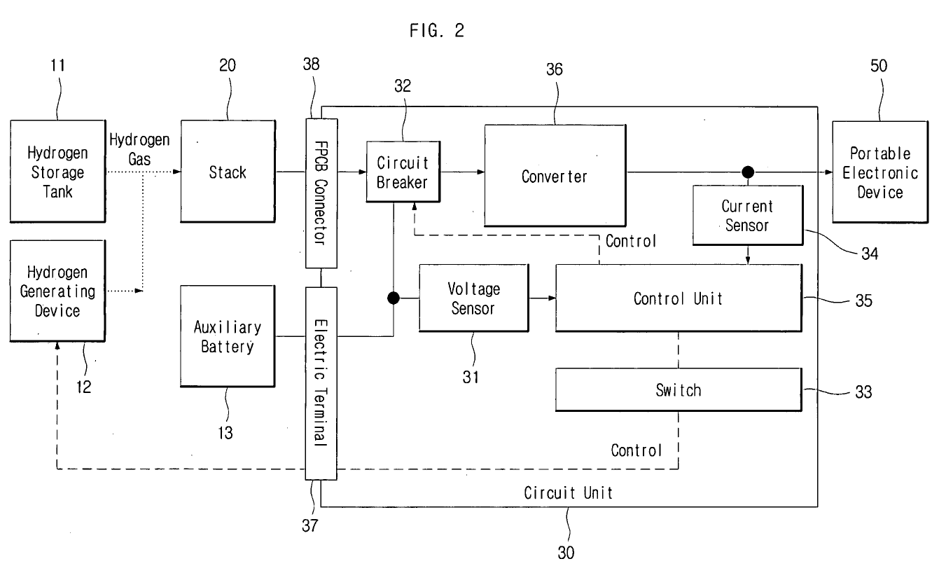

FIG. 1 is a perspective view of an embodiment of an electric power supply apparatus according to an aspect of the invention, and FIG. 2 is a conceptual diagram of an embodiment of an electric power supply apparatus according to an aspect of the invention. In FIG. 1 and FIG. 2, there are illustrated a cartridge 10, a hydrogen storage tank 11, a hydrogen generating device 12, an auxiliary battery 13, a manifold 14, a stack 20, openings 25, a circuit unit 30, a voltage sensor 31, a circuit breaker 32, a switch 33, a current sensor 34, a control unit 35, a converter 36, an electric terminal 37, an FPCB connector 38, and a housing 40.

The electric power supply apparatus can be an apparatus for supplying electrical energy to an electronic device and can be mounted onto smaller-sized, portable electronic devices. For convenience, this embodiment will be described using a portable electronic device as an example of the electronic device, but it is to be appreciated that the electronic device can be any device that generally uses electrical energy, other than a portable electronic device.

The cartridge 10 can supply hydrogen or supply electrical power. For example, the cartridge can be a hydrogen storage tank 11, a hydrogen generating device 12, or an auxiliary battery 13. An auxiliary battery 13 may refer to a battery capable of supplying electrical power, such as a lithium ion battery, a lithium polymer battery, and an alkaline primary cell, etc. A hydrogen generating device 12 can be a device capable of generating hydrogen by having metal electrodes react with an electrolyte solution. The hydrogen generating device 12 can include a pair of metal electrodes having different ionization energies, and an aqueous electrolyte solution. At the oxidation electrode, which has the higher ionization energy, the metal of the electrode may be ionized to provide electrons, which may react with the water of the aqueous electrolyte solution at the reduction electrode to generate hydrogen.

A hydrogen storage tank 11 may refer to a cartridge that stores hydrogen in a compressed form.

The cartridge 10 can be of a replaceable type, and can be connected with the circuit unit 30 and the manifold 14 simply by inserting into the housing 40. However, if it is possible to supply electrical power directly, as in the case of an auxiliary battery 13, the cartridge 10 may not have to be connected with the manifold 14. The cartridge 10 can be electrically connected with the circuit unit 30 through contact with the electric terminal 37, and in cases where the cartridge 10 is a hydrogen storage tank 11 or a hydrogen generating device 12 for supplying hydrogen, the cartridge can also be connected with the manifold 14.

The manifold 14 can receive the hydrogen from the hydrogen storage tank 11 or hydrogen generating device 12 and supply the hydrogen to the stack 20. The manifold 14 may serve to adjust the pressure of the hydrogen supplied from the hydrogen storage tank 11 or hydrogen generating device 12, so that a constant amount of hydrogen may be supplied to the stack 20.

The stack 20 can be a device that generates electrical energy using hydrogen as fuel, in cases where the cartridge 10 is a hydrogen storage tank 11 or a hydrogen generating device 12. The basic structure of a unit cell may include an electrolyte layer placed between an air electrode and a fuel electrode. Several basic units, each having a fuel cell, an electrolyte layer, and an air electrode, can be layered together to form a stack, with separation plates dividing the basic units. In the drawings, a flat stack 20 is illustrated that has a single layer of unit cell. The flat type may be formed as a single layer, without having the basic unit cells stacked together, and may thus be suited for use in smaller electronic devices, such as a portable electronic device 50. Openings 25 can be formed in one side, so that oxygen may be supplied to the air electrode, thereby obviating the need to forcibly inject oxygen using a pump.

The stack 20 can be coupled to one side of the housing 40 and can be arranged adjacent to the cartridge 10. In cases where the cartridge 10 is a hydrogen generating device 12, the operations for generating hydrogen may require thermal energy, and as this arrangement allows the heat generated in the stack 20 to be transferred to the cartridge 10, a higher efficiency can be obtained without wasting energy.

The hydrogen supplied to the fuel electrode of the stack 20 may be separated into hydrogen ions and electrons, where the hydrogen ions may move through the electrolyte layer to the air electrode and the electrons may move through an external circuit to the air electrode. At the air electrode, oxygen ions and hydrogen ions may combine to produce water.

The chemical equation for the reactions present in the stack 20 can be represented as follows by Reaction Scheme 1.

Fuel Electrode: H₂→2H⁺+2e⁻

Air Electrode: ½ O₂+2H⁺+2e⁻=H₂O

Overall Reaction: H₂+½ O₂=H₂O [Reaction Scheme 1]

The circuit unit 30 can serve to receive electrical power from the cartridge 10 or the stack 20 and supply the electrical power to the portable electronic device 50 after raising or reducing the voltage to a level required by the portable electronic device 50. Also, the circuit unit 30 can adjust the amount of hydrogen generated by the hydrogen generating device 12 and can prevent backflow in the electrical current.

A generalized diagram of the composition of the circuit unit 30 is illustrated in FIG. 2, in which a voltage sensor 31, a circuit breaker 32, a switch 33, a current sensor 34, a control unit 35, an FPCB connector 38, a converter 36, and an electric terminal 37 are illustrated.

The cartridge 10 can be electrically connected with the circuit unit 30 by way of the electric terminal 37, and the stack 20 can be connected with the circuit unit 30 by way of the FPCB connector 38. The circuit unit 30 can be supplied with electrical power from the cartridge 10 or from the stack 20 and can supply the electrical power through the converter 36 to the portable electronic device 50. The converter 36 can raise or lower the voltage supplied from the cartridge or stack, to supply a voltage to the portable electronic device 50 at an appropriate level as required by the portable electronic device 50.

A switch 33 can be included for controlling the amount of hydrogen generation in cases where the cartridge 10 is a hydrogen generating device 12. The switch 33 may control the flow of electrons between the electrodes of the hydrogen generating device 12 in an on/off manner. The current sensor 34 may measure the electric current of the portable electronic device 50, and the circuit unit 30 may further include a control unit 35, which may control the switch 33 such that the hydrogen may be generated in an amount corresponding to the electric current measured by the current sensor 34. This control unit 35 may not only control the amount of hydrogen generation in the hydrogen generating device, but may also oversee the control mechanisms of the entire circuit, as will be described later.

The voltage sensor 31 can measure the voltage of the electric power supplied by the cartridge 10. If the cartridge 10 connected to the circuit unit 30 is an auxiliary battery 13, the voltage may be relatively high, but if the cartridge 10 is a hydrogen generating device 12 or a hydrogen storage tank 11, the voltage of the electrical power generated by the stack 20 may be relatively lower.

Using these characteristics, the cartridge 10 may be identified as an auxiliary battery 13 if the measured voltage is above a particular reference value, and as a hydrogen storage tank 11 or a hydrogen generating device 12 if otherwise. For example, the cartridge 10 may be determined to be an auxiliary battery 13 if a voltage of 2 V or higher is measured, and may be determined to be a device supplying hydrogen if the voltage is lower than 2 V.

Such determination may be performed in an integrated manner by the control unit 35, where the method of supplying electrical power to the portable electronic device 50 may vary depending on the results of the determination performed by the control unit. If the cartridge 10 is identified as an auxiliary battery 13, the control unit 35 may operate the circuit breaker 32 such that the electric current flowing from the auxiliary battery 13 does not flow towards the stack 20. The circuit breaker 32 can be a diode that controls the electric current to flow in one direction.

Looking again at the mechanisms in the circuit unit 30 in recap, first, the control unit 25 may measure the voltage of the cartridge 10 or the stack 20, when the cartridge 10 is installed, to determine whether the cartridge is an auxiliary battery 13 or a hydrogen storage tank 11 or hydrogen generating device 12.

If the results of the determination show that the cartridge 10 is an auxiliary battery 13, the control unit 35 may operate the circuit breaker 32 and control the electric current such that the current does not flow to the stack. The supplied voltage may be converted by the converter 36 to a level suited for the portable electronic device 50 and then supplied to the portable electronic device 50.

If the determination results show that the cartridge 10 is a hydrogen storage tank 11, the hydrogen may be supplied to the stack 20,-and the electrical power generated by the stack 20 may be supplied through the converter 36 to the portable electronic device 50. If the determination results show that the cartridge 10 is a hydrogen generating device 12, the control unit 35 may control the amount of hydrogen generation in the hydrogen generating device 12, while the stack 20 may receive the hydrogen and generate electricity to supply the electrical power through the converter 36 to the portable electronic device 50, as in the case for the hydrogen storage tank 11.

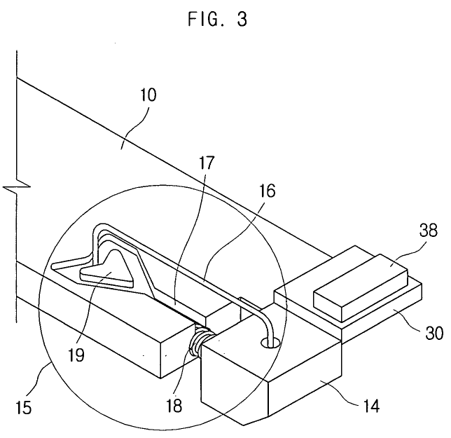

The electric power supply apparatus can include a securing unit 15, which may allow the cartridge 10 to be readily engaged and disengaged. FIG. 3 is a perspective view of an embodiment of a securing unit 15 in an electric power supply apparatus according to an aspect of the invention, in which a securing unit 15 is shown that includes a rail bar 16, a rail 17, a spring 18, and a lock 19.

If the cartridge 10 is engaged with the securing unit 15, applying pressure on the engaged cartridge 10 can separate the cartridge 10 from the securing unit 15. That is, as the rail bar 16 proceeds along the rail 17, the cartridge 10 can be secured when the rail bar 16 is caught on the lock 19 formed at the end of the rail 17. When pressure is applied again to the cartridge 10, the rail bar 16 may escape the lock 19, at which the cartridge 10 can be pushed by the spring 18 and separated from the housing 40. The securing unit 15 can be formed on various positions other than the manifold 14, such as inside the housing 40 and on the circuit unit 30, etc.

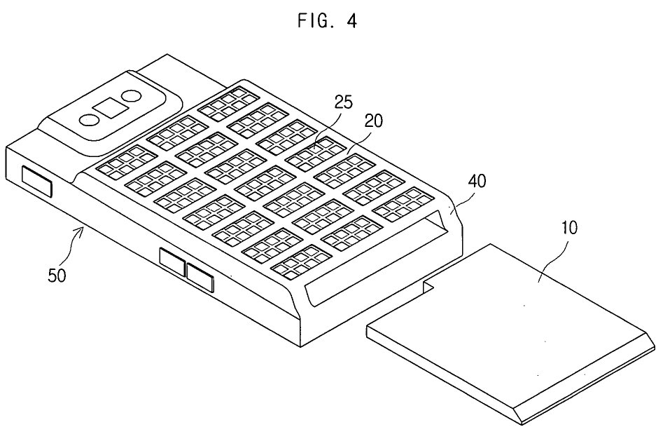

FIG. 4 is a perspective view of an embodiment of a portable electronic device 50 according to another aspect of the invention, in which a portable electronic device 50 is shown that uses the electric power supply apparatus as its main power source. A portable cell phone is illustrated as an example of a portable electronic device 50, but it is to be appreciated that the portable electronic device 50 can be any of various devices other than a portable cell phone, such as an MP3 player, a PMP (portable media player), a PDA (personal digital assistant), and electronic dictionary, etc. Embodiments of the invention are also applicable to larger-sized electronic devices.

As shown in the drawing, the cartridge 10 can be shaped to allow engaging and disengaging. Openings 25 can be formed in the air electrode portions of the stack 20, to allow a supply of oxygen. The electric power supply apparatus may be substantially the same as described above.

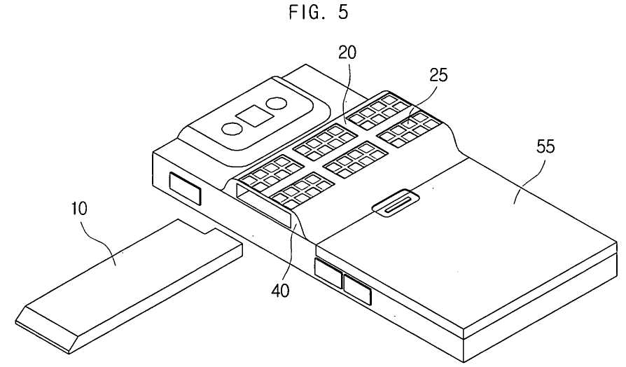

FIG. 5 is a perspective view of another embodiment of a portable electronic device 50 according to another aspect of the invention, in which a portable cell phone is shown that uses the electric power supply apparatus as an auxiliary power source. That is, unlike the embodiment illustrated in FIG. 4, a main battery 55 may further be included. A rechargeable main battery 55 may function as the main power source, and when the power level of the main power source is low, an electric power supply apparatus based on an embodiment of the invention can be used to supply electrical power for recharging the main battery 55.

As set forth above, with certain embodiments of the invention, a device can be recharged using replaceable cartridges. Also, various types of cartridges can be used in a single system, allowing a higher level of compatibility.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

Many embodiments other than those set forth above can be found in the appended claims.

What is claimed is:

1. An electric power supply apparatus for supplying electrical power to an electronic device, the electric power supply apparatus comprising:
a replaceable cartridge configured to supply hydrogen or electrical power;
a housing forming a cavity, the cartridge configured to be inserted in the cavity;
a stack connected with the cartridge, the stack configured to receive the hydrogen from the cartridge and generate electrical power, if the cartridge is supplying hydrogen; and
a circuit unit electrically connected with the cartridge and the stack, the circuit unit configured to determine a type of the cartridge and supply electrical power to the electronic device.

2. The electric power supply apparatus of claim 1, wherein the cartridge is one of a hydrogen generating device, a hydrogen storage tank, and an auxiliary battery.

3. The electric power supply apparatus of claim 1, wherein the circuit unit comprises a voltage sensor,
the voltage sensor configured to measure a voltage of the cartridge or the stack and sense whether the cartridge is supplying hydrogen or electrical power.

4. The electric power supply apparatus of claim 3, wherein the circuit unit comprises a circuit breaker,
the circuit breaker configured to break an electric current flowing to the stack, if the voltage sensor senses that the cartridge is supplying electrical power.

5. The electric power supply apparatus of claim 1, further comprising:
a manifold interposed between the cartridge and the stack,
the manifold configured to receive the hydrogen from the cartridge and transfer the hydrogen to the stack, if the cartridge is supplying hydrogen.

6. The electric power supply apparatus of claim 1, wherein the cartridge is a hydrogen generating device comprising metal electrodes configured to react with an electrolyte solution and generate hydrogen, and
the circuit unit comprises a switch configured to control an electric current flowing between the electrodes of the hydrogen generating device.

7. The electric power supply apparatus of claim 6, wherein the circuit unit comprises:
a current sensor configured to measure an electric current flowing to the electronic device; and
a control unit configured to control the switch such that the hydrogen is generated in an amount corresponding to the current measured by the current sensor.

8. The electric power supply apparatus of claim 1, wherein the circuit unit comprises a converter,
the converter configured to adjust a voltage supplied from the cartridge or the stack.

9. The electric power supply apparatus of claim 1, further comprising:
a securing unit,
the securing unit configured to engage the cartridge when the cartridge is inserted in the housing by pressure applied to the cartridge,
the securing unit configured to disengage the cartridge when pressure is applied again to the engaged cartridge.

10. The electric power supply apparatus of claim 1, wherein the stack is coupled to one side of the housing.

11. The electric power supply apparatus of claim 1, wherein the stack has an opening formed in one side thereof.

12. A portable electronic device comprising an electric power supply apparatus and operated by electrical energy supplied by the electric power supply apparatus, the electric power supply apparatus comprising:
a replaceable cartridge configured to supply hydrogen or electrical power;
a housing forming a cavity, the cartridge configured to be inserted in the cavity;
a stack connected with the cartridge, the stack configured to receive the hydrogen from the cartridge and generate electrical power, if the cartridge supplies hydrogen; and
a circuit unit electrically connected with the cartridge and the stack, the circuit unit configured to determine a type of the cartridge and supply electrical power to the electronic device.

13. The portable electronic device of claim 12, wherein the cartridge is one of a hydrogen generating device, a hydrogen storage tank, and an auxiliary battery.

14. The portable electronic device of claim 12, wherein the circuit unit comprises a voltage sensor,
the voltage sensor configured to measure a voltage of the cartridge or the stack and sense whether the cartridge is supplying hydrogen or electrical power.

15. The portable electronic device of claim 14, wherein the circuit unit comprises a circuit breaker,
the circuit breaker configured to break an electric current flowing to the stack, if the voltage sensor senses that the cartridge is supplying electrical power.

16. The portable electronic device of claim 12, wherein the electric power supply apparatus comprises:
a manifold interposed between the cartridge and the stack,
the manifold configured to receive the hydrogen from the cartridge and transfer the hydrogen to the stack, if the cartridge is supplying hydrogen.

17. The portable electronic device of claim 12, wherein the cartridge is a hydrogen generating device comprising metal electrodes configured to react with an electrolyte solution and generate hydrogen, and
the circuit unit comprises a switch configured to control an electric current flowing between the electrodes of the hydrogen generating device.

18. The portable electronic device of claim 17, wherein the circuit unit comprises:
a current sensor configured to measure an electric current flowing to the electronic device; and
a control unit configured to control the switch such that the hydrogen is generated in an amount corresponding to the current measured by the current sensor.

19. The portable electronic device of claim 12, wherein the circuit unit comprises a converter,
the converter configured to adjust a voltage supplied from the cartridge or the stack.

20. The portable electronic device of claim 12, wherein the electric power supply apparatus comprises:
a securing unit,
the securing unit configured to engage the cartridge when the cartridge is inserted in the housing by pressure applied to the cartridge,
the securing unit configured to disengage the cartridge when pressure is applied again to the engaged cartridge.

21. The portable electronic device of claim 12, wherein the stack is coupled to one side of the housing.

22. The portable electronic device of claim 12, wherein the stack has an opening formed in one side thereof.

23. The portable electronic device of claim 12, further comprising a rechargeable main battery,
wherein the electric power supply apparatus is electrically connected with the main battery and configured to recharge the main battery.
